(19) United States
(12) Patent Application Publication
(10) Pub. No.: US 2026/0351181 A1
(43) Pub. Date: Nov. 5, 2026

(54) PIXEL CIRCUIT, DRIVING METHOD THEREOF, AND DISPLAY PANEL

(71) Applicant: Beijing Visionox Technology Co., Ltd., Beijing (CN)

(72) Inventors: Shuang GUO, Beijing (CN); Enqing GUO, Beijing (CN); Lei MI, Beijing (CN); Yun CHENG, Beijing (CN)

(73) Assignee: Beijing Visionox Technology Co., Ltd., Beijing (CN)

(21) Appl. No.: 19/719,146

(22) Filed: Jun. 24, 2026

(30) Foreign Application Priority Data
Dec. 26, 2025 (CN) 202512003371.6

(51) Int. Cl. G09G 3/3233

(52) U.S. Cl. CPC G09G 3/3233; G09G 2300/0819; G09G 2300/0842; G09G 2300/0866; G09G 2310/08; G09G 2320/0209; G09G 2320/0233; G09G 2320/0257; G09G 2320/045; G09G 2330/021

(57) ABSTRACT

The present application discloses a pixel circuit, a driving method for the pixel circuit, and a display panel. The pixel circuit includes a driving module, a light emission control module, and a compensation module. A first terminal of the driving module is connected to a first power line, and the first power line is configured to transmit a first power voltage and a data voltage to the first terminal of the driving module in a time-division manner; a first terminal of the light emission control module is connected to a second terminal of the driving module, a second terminal of the light emission control module is connected to a first terminal of a light emitting device, and the light emission control module is configured to control whether the driving module generates a driving current; the compensation module is connected between the second terminal of the light emission control module and a control terminal of the driving module, and the compensation module is configured to, when turned on, transmit a voltage related to the data voltage and a threshold voltage of a transistor in the driving module to the control terminal of the driving module. The technical solution of the present application improves the use performance of the display panel.

### CROSS REFERENCE TO RELATED APPLICATION

The present application claims priority to Chinese Patent Application No. 202512003371.6, filed on Dec. 26, 2025, which is incorporated herein by reference in its entirety.

### FIELD

The present application relates to the field of display technology, and in particular to a pixel circuit, a driving method for the pixel circuit, and a display panel.

### BACKGROUND

Flat panel display devices based on Organic Light Emitting Display (OLED) and Light Emitting Diode (LED) technologies have advantages such as high image quality, power saving, a thin body, and a wide application range, and have been widely applied to various consumer electronic products such as mobile phones, televisions, laptop computers, and desktop computers, becoming mainstream in display devices.

However, the use performance of current OLED display products needs to be improved.

### SUMMARY

The present application provides a pixel circuit, a driving method for the pixel circuit, and a display panel, to improve the use performance of the display panel.

According to one aspect of the present application, a pixel circuit includes a driving module, a light emission control module, a reset module, and a compensation module.

The compensation module includes a compensation transistor; the light emission control module includes a light emission control transistor; the reset module includes a reset transistor.

The reset transistor is an oxide transistor, and a driving transistor is a polysilicon transistor.

In an embodiment, the light emission control transistor is a polysilicon transistor, and the compensation transistor is an oxide transistor.

In an embodiment, a storage module includes a storage capacitor.

A first terminal of the driving module is connected to a first power line. The first power line is configured to transmit a first power voltage and a data voltage to the first terminal of the driving module in a time-division manner.

A first terminal of the light emission control module is connected to a second terminal of the driving module, a second terminal of the light emission control module is connected to a first terminal of a light emitting device, and the light emission control module is configured to control the driving module to generate a driving current.

The compensation module is connected between the second terminal of the light emission control module and a control terminal of the driving module, and the compensation module is configured to, when turned on, transmit a voltage related to the data voltage and a threshold voltage of a transistor in the driving module to the control terminal of the driving module.

The pixel circuit further includes a reset module. The reset module is connected between a reset signal line and the second terminal of the light emission control module, a control terminal of the reset module is connected to a second scan line, and the reset module is configured to, during a first reset stage, turn on in response to a second scan signal on the second scan line to transmit a reset voltage on the reset signal line to the second terminal of the light emission control module; the pixel circuit further includes a storage module. A first terminal of the storage module is connected to a third power line, a second terminal of the storage module is connected to the control terminal of the driving module, and the storage module is configured to maintain a potential of the control terminal of the driving module.

According to another aspect of the present application, a driving method for a pixel circuit is provided. The pixel circuit includes: a driving module, a light emission control module, and a compensation module. A first terminal of the driving module is connected to a first power line, a first terminal of the light emission control module is connected to a second terminal of the driving module, a second terminal of the light emission control module is connected to a first terminal of a light emitting device, and the compensation module is connected between the second terminal of the light emission control module and a control terminal of the driving module.

The present application includes a driving method.

During a data writing stage, controlling the first power line to transmit a data voltage to the first terminal of the driving module, controlling the light emission control module and the compensation module to turn on, and transmitting a voltage related to the data voltage and a threshold voltage of a transistor in the driving module to the control terminal of the driving module;

During a light emission stage, controlling the light emission control module to turn on, to cause the driving module to generate a driving current.

In one embodiment, the pixel circuit further includes a reset module, and the reset module is connected between a reset signal line and the second terminal of the light emission control module;

Before the data writing stage, the driving method further includes:

During a first reset stage, controlling the compensation module and the reset module to turn on, to cause the reset module to transmit a reset voltage on the reset signal line to the second terminal of the light emission control module, and the compensation module to transmit the reset voltage to the control terminal of the driving module.

According to another aspect of the present application, a display panel is provided, and the display panel includes a plurality of pixel circuits, and the pixel circuits are the pixel circuits according to any embodiment of the present application.

A control terminal of a light emission control module in the pixel circuit is connected to a light emission control line, and the light emission control module is configured to, during a data writing stage and a light emission stage, turn on in response to an active level of a light emission control signal on the light emission control line.

Control terminals of light emission control modules in one row of the pixel circuits are connected to a same light emission control line.

During the data writing stage in one display frame, an active level of a light emission control signal corresponding to an (m+1)th row of pixel circuits is delayed by one row time relative to an active level of a light emission control signal corresponding to an mth row of pixel circuits; and m is a positive integer.

During a light emission stage in the one display frame, light emission control signals corresponding to all of the pixel circuits simultaneously transition from an inactive level to an active level.

The embodiments of the present application provide a compensation module. The compensation module is configured to, when turned on, transmit a voltage related to a data voltage and a threshold voltage of a transistor in a driving module to a control terminal of the driving module, and a driving current generated by the driving module is independent of the threshold voltage of the transistor in the driving module, which may avoid changes in the driving current caused by fluctuations in the threshold voltage of the transistor in the driving module. Moreover, a problem where different driving modules produce different driving currents under a same gray level, due to different threshold voltages of transistors in the different driving modules caused by process reasons, may be avoided. In one embodiment, driving currents generated by different driving modules under a same gray level may be close or identical, and light emission brightness of different light emitting devices under a same gray level is the same, which is beneficial to improving display uniformity of a display panel, improving display effects of the display panel, and thus improving the use performance of the display panel. By configuring a first power line to transmit a first power voltage and the data voltage to a first terminal of the driving module in a time-division manner, the number of devices may be reduced, which facilitates achieving a higher pixel density, and spacing between various devices does not need to be excessively small, thereby reducing parasitic capacitance between the various devices and traces, reducing crosstalk between signals, and reducing an impact on the light emission brightness of light emitting devices, which is beneficial to improving the display effects of the display panel, and thus improving the use performance of the display panel.

The content described in this section is not intended to identify key or important features of the embodiments of the present application, nor is the content used to limit the scope of the present application. Other features of the present application will become easily understood through the following description.

### BRIEF DESCRIPTION OF DRAWINGS

To more clearly illustrate the embodiments of the present application, the drawings required for use in the description of the embodiments will be briefly introduced below.

FIG. 1 is a structural schematic diagram of a pixel circuit provided by an embodiment of the present application;

FIG. 2 is a structural schematic diagram of another pixel circuit provided by an embodiment of the present application;

FIG. 3 is a structural schematic diagram of yet another pixel circuit provided by an embodiment of the present application;

FIG. 4 is a driving timing diagram of a pixel circuit provided by an embodiment of the present application;

FIG. 5 is a structural schematic diagram of yet another pixel circuit provided by an embodiment of the present application;

FIG. 6 is a structural schematic diagram of yet another pixel circuit provided by an embodiment of the present application;

FIG. 7 is a simulation timing diagram provided by an embodiment of the present application;

FIG. 8 is a structural schematic diagram of yet another pixel circuit provided by an embodiment of the present application;

FIG. 9 is a flowchart of a driving method for a pixel circuit provided by an embodiment of the present application;

FIG. 10 is a structural schematic diagram of a display panel provided by an embodiment of the present application;

FIG. 11 is a driving timing diagram of a display panel provided by an embodiment of the present application;

FIG. 12 is a structural schematic diagram of another display panel provided by an embodiment of the present application;

FIG. 13 is a structural schematic diagram of yet another display panel provided by an embodiment of the present application.

### DETAILED DESCRIPTION

To enable those to better understand the solutions of the present application, the embodiments of the present application will be clearly and completely described below with reference to the drawings in the embodiments of the present application. In one embodiment, the described embodiments are only part of the embodiments of the present application, not all of the embodiments.

The use performance of existing display panels needs to be improved. The reason for this issue is that a display panel includes pixel circuits and light emitting devices, the pixel circuits are connected to the light emitting devices, and the pixel circuits may generate driving currents to drive the light emitting devices to emit light. The pixel circuit in the related art is a 7T1C pixel circuit, and the pixel circuit includes a data writing transistor, a threshold compensation transistor, a first initialization transistor, a second initialization transistor, a first light emission control transistor, a second light emission control transistor, and a storage capacitor. The pixel circuit includes many devices, making it difficult to meet the demand for a higher Pixels Per Inch (PPI). If the demand for high pixel density is to be met, the spacing between devices will be very small, resulting in a large parasitic capacitance between devices and a large crosstalk between devices and traces, and between traces and traces, which means a large crosstalk between signals, affecting the light emission brightness of the light emitting devices, thereby affecting the display effects of the display panel and resulting in poor use performance of the display panel.

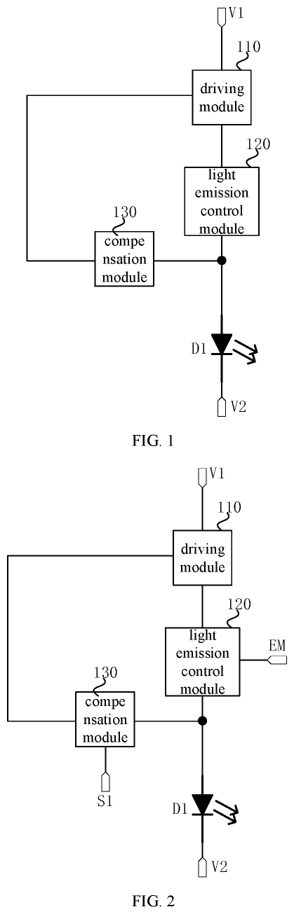

In view of the above problems, embodiments of the present application provide a pixel circuit. FIG. 1 is a structural schematic diagram of a pixel circuit provided by an embodiment of the present application.

Referring to FIG. 1, the pixel circuit includes a driving module 110, a light emission control module 120, and a compensation module 130.

A first terminal of the driving module 110 is connected to a first power line V1, and the first power line V1 is configured to transmit a first power voltage and a data voltage to the first terminal of the driving module 110 in a time-division manner.

A first terminal of the light emission control module 120 is connected to a second terminal of the driving module 110, a second terminal of the light emission control module 120 is connected to a first terminal of a light emitting device D1, and the light emission control module 120 is configured to control the driving module 110 to generate a driving current. When the light emission control module 120 turns on, the driving module 110 generates a driving current. When the light emission control module 120 turns off, the driving module 110 stops generating the driving current.

The compensation module 130 is connected between the second terminal of the light emission control module 120 and a control terminal of the driving module 110. The compensation module 130 is configured to, when turned on, transmit a voltage related to the data voltage and a threshold voltage of a transistor in the driving module 110 to the control terminal of the driving module 110.

The light emitting device D1 may be an organic light emitting diode. The first power line V1 may transmit a first power voltage and a data voltage to the first terminal of the driving module 110 in a time-division manner, and the driving module 110 may generate a driving current according to the data voltage to drive the light emitting device D1 to emit light. The light emission control module 120 may control whether the driving module 110 generates a driving current. For example, when the light emission control module 120 is turned on, the first power line V1, the driving module 110, the light emission control module 120, and the light emitting device D1 may form a current path, and the driving module 110 may generate a driving current. When the light emission control module 120 is turned off, the driving module 110 cannot generate a driving current.

When the compensation module 130 is turned on, a voltage on the first power line V1 (for example, a data voltage) may charge or discharge the control terminal of the driving module 110 through the driving module 110, the light emission control module 120, and the compensation module 130, until a voltage of the control terminal of the driving module 110 becomes a voltage related to a threshold voltage of a transistor in the driving module 110, and the driving module 110 is turned off, thereby achieving transmission of a voltage related to the data voltage and the threshold voltage of the transistor in the driving module 110 to the control terminal of the driving module 110. A driving current generated by the driving module 110 is related to a voltage difference between a voltage of the control terminal of the driving module 110 minus a voltage of the first terminal of the driving module 110, and then minus the threshold voltage of the transistor in the driving module 110, and the voltage of the control terminal of the driving module 110 is a voltage related to the threshold voltage of the transistor in the driving module 110, and the threshold voltage of the transistor in the driving module 110 may be eliminated from an expression of the driving current. That is, the driving current is independent of the threshold voltage of the transistor in the driving module 110, thereby avoiding changes in the driving current caused by fluctuations in the threshold voltage of the transistor in the driving module 110. Moreover, a problem where different driving modules 110 have different threshold voltages of transistors due to different characteristics of the transistors caused by process reasons, and different driving modules 110 generate different driving currents under a same gray level, may be avoided. In one embodiment, driving currents generated by different driving modules 110 under a same gray level may be close or identical, and light emission brightness of different light emitting devices D1 under a same gray level is the same, which is beneficial to improving display uniformity of a display panel, improving display effects of the display panel, and thus improving the use performance of the display panel.

By configuring the first power line V1 to transmit a first power voltage and a data voltage to the first terminal of the driving module 110 in a time-division manner, the number of devices may be reduced, and there is no need to provide two transistors to transmit the first power voltage and the data voltage, which is beneficial to reducing an occupied space of the pixel circuit and facilitating achievement of a higher pixel density. Moreover, the pixel circuit includes fewer devices, and spacing between various devices does not need to be excessively small, thereby reducing parasitic capacitance between the various devices and traces, reducing crosstalk between signals, and reducing an impact on the light emission brightness of the light emitting device D1, which is beneficial to improving display effects of the display panel, and thus improving the use performance of the display panel.

Furthermore, by configuring the compensation module 130 to be connected between the second terminal of the light emission control module 120 and the control terminal of the driving module 110, a threshold compensation may be performed only when both the light emission control module 120 and the compensation module 130 are turned on. That is, a control of a driving timing is achieved through a cooperation of the light emission control module 120 and the compensation module 130, and when the light emission control module 120 or the compensation module 130 is turned on alone, other stages of the driving timing may be executed. For example, when the compensation module 130 is turned on and the light emission control module 120 is not turned on, the control terminal of the driving module 110 may be reset through the compensation module 130, avoiding the driving module 110 being turned on during a reset and causing the light emitting device D1 to emit light erroneously. In one embodiment, the pixel circuit may work better while using fewer devices.

The embodiments of this embodiment, by providing a compensation module. The compensation module is configured to, when turned on, transmit a voltage related to a data voltage and a threshold voltage of a transistor in a driving module to a control terminal of the driving module, and a driving current generated by the driving module is independent of the threshold voltage of the transistor in the driving module, which may avoid changes in the driving current caused by fluctuations in the threshold voltage of the transistor in the driving module. Moreover, a problem where different driving modules produce different driving currents under a same gray level, due to different threshold voltages of transistors in the different driving modules caused by process reasons, may be avoided. In one embodiment, driving currents generated by different driving modules under a same gray level may be close or identical, and light emission brightness of different light emitting devices under a same gray level is the same, which is beneficial to improving display uniformity of a display panel, improving display effects of the display panel, and thus improving the use performance of the display panel. By configuring a first power line to transmit a first power voltage and a data voltage to a first terminal of the driving module in a time-division manner, the number of devices may be reduced, which facilitates achieving a higher pixel density, and spacing between various devices does not need to be excessively small, thereby reducing parasitic capacitance between the various devices and traces, reducing crosstalk between signals, and reducing an impact on the light emission brightness of the light emitting devices, which is beneficial to improving the display effects of the display panel, and thus improving the use performance of the display panel.

In some embodiments, as shown in FIG. 1, a second terminal of the light emitting device D1 is connected to a second power line V2. The second power line V2 is configured to transmit a second power voltage and a third power voltage to the second terminal of the light emitting device D1 in a time-division manner. In one embodiment, the third power voltage is smaller than the second power voltage.

The first terminal of the light emitting device D1 is an anode and the second terminal of the light emitting device D1 is a cathode; or, the first terminal of the light emitting device D1 is a cathode and the second terminal of the light emitting device D1 is an anode, which is not limited herein.

The second power line V2 transmits the second power voltage and the third power voltage to the second terminal of the light emitting device D1 in a time-division manner. For example, during at least a part of a non-light emission stage, the second power line V2 transmits the second power voltage to the second terminal of the light emitting device D1, the second power voltage is relatively large, which may make a voltage difference between a voltage of the first terminal of the light emitting device D1 and the second power voltage smaller than a turn-on voltage (i.e., a conduction voltage) of the light emitting device D1, which can ensure that the light emitting device D1 does not emit light during the non-light emission stage. During a light emission stage, the second power line V2 transmits the third power voltage to the second terminal of the light emitting device D1, the third power voltage is relatively small, which may make a voltage difference between a voltage of the first terminal of the light emitting device D1 and the third power voltage greater than or equal to a working voltage (i.e., a conduction voltage) of the light emitting device D1, which can ensure that the light emitting device D1 emits light during the light emission stage. In one embodiment, the number of devices may be further reduced without needing to provide two transistors to transmit the second power voltage and the third power voltage, thereby being beneficial to reducing an occupied space of the pixel circuit and facilitating achievement of a higher pixel density. Moreover, the pixel circuit includes fewer devices, and spacing between various devices does not need to be excessively small, thereby reducing parasitic capacitance between the various devices and traces, reducing crosstalk between signals, and reducing an impact on the light emission brightness of the light emitting device D1, which is beneficial to improving display effects of the display panel, and thus improving the use performance of the display panel.

Furthermore, the second power line V2 transmits the second power voltage and the third power voltage to the second terminal of the light emitting device D1 in a time-division manner, and by controlling whether the light emission control module 120 is turned on and a voltage of the second terminal of the light emitting device D1, for example, the light emitting device D1 can emit light only when the light emission control module 120 is turned on and a voltage of the second terminal of the light emitting device D1 is a third power terminal voltage, and only one light emission control module 120 is needed, without providing two light emission control modules, which can reduce the number of devices in the pixel circuit and facilitate improving a pixel density of the display panel.

In one embodiment, as shown in FIG. 1, the third power voltage is smaller than zero, and the second power voltage is greater than zero. This can ensure that a voltage difference between a voltage of the first terminal of the light emitting device D1 and the second power voltage is small, smaller than a working voltage of the light emitting device D1, and a voltage difference between a voltage of the first terminal of the light emitting device D1 and the third power voltage is large, greater than a working voltage of the light emitting device D1.

FIG. 2 is a structural schematic diagram of another pixel circuit provided by an embodiment of the present application. In one embodiment, referring to FIG. 2, a first control terminal of the compensation module 130 is connected to a first scan line S1, and the compensation module 130 is configured to, at least during a data writing stage, turn on in response to a first scan signal on the first scan line S1.

A control terminal of the light emission control module 120 is connected to a light emission control line EM, and the light emission control module 120 is configured to, during a data writing stage and a light emission stage, turn on in response to a light emission control signal on the light emission control line EM.

The first power line V1 is configured to, during the data writing stage, transmit a data voltage to the first terminal of the driving module 110, and during the light emission stage, transmit a first power voltage to the first terminal of the driving module 110.

The second power line V2 is configured to, during the data writing stage, transmit a second power voltage to the second terminal of the light emitting device D1, and during the light emission stage, transmit a third power voltage to the second terminal of the light emitting device D1.

During the data writing stage, the driving module 110, the light emission control module 120, and the compensation module 130 are turned on, and a data voltage on the first power line V1 charges or discharges the control terminal of the driving module 110 through the driving module 110, the light emission control module 120, and the compensation module 130, until a voltage of the control terminal of the driving module 110 becomes a voltage related to a threshold voltage of a transistor in the driving module 110, and the driving module 110 is turned off, thereby achieving transmission of a voltage related to the data voltage and the threshold voltage of the transistor in the driving module 110 to the control terminal of the driving module 110. In one embodiment, a data writing and a threshold compensation are achieved during the data writing stage. Moreover, the second power line V2 transmits the second power voltage to the second terminal of the light emitting device D1 during the data writing stage. The second power voltage is relatively large, making a voltage difference across the light emitting device D1 small, which can ensure that the light emitting device D1 does not emit light during the data writing stage.

During the light emission stage, the first power line V1 transmits the first power voltage to the first terminal of the driving module 110, and the light emission control module 120 is turned on. For example, the first power voltage is greater than the third power voltage, and the first power line V1, the driving module 110, the light emission control module 120, the light emitting device D1, and the second power line V2 form a current path, enabling the driving module 110 to generate a driving current to drive the light emitting device D1 to emit light.

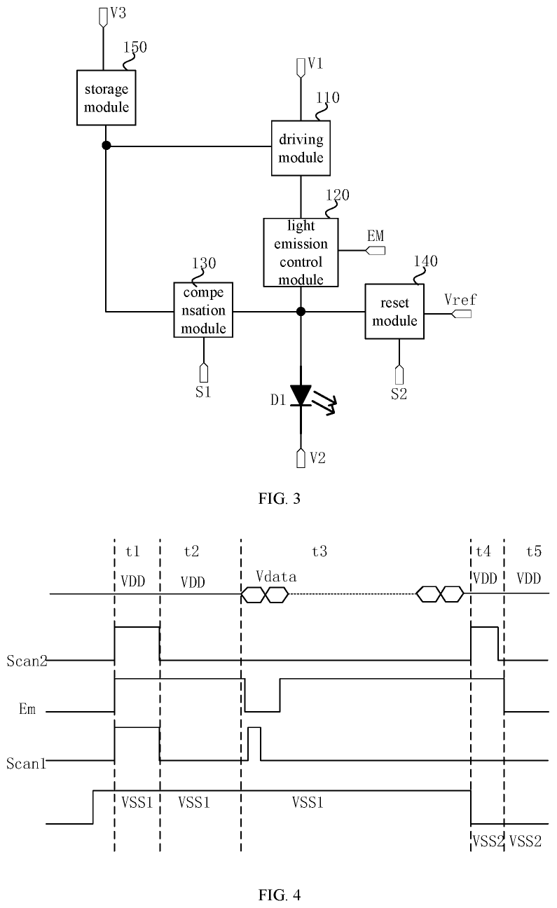

In some embodiments, FIG. 3 is a structural schematic diagram of yet another pixel circuit provided by an embodiment of the present application. In one embodiment, referring to FIG. 3, the pixel circuit further includes a reset module 140.

The reset module 140 is connected between a reset signal line Vref and the second terminal of the light emission control module 120. A control terminal of the reset module 140 is connected to a second scan line S2. The reset module 140 is configured to, during a first reset stage, turn on in response to a second scan signal on the second scan line S2 to transmit a reset voltage on the reset signal line Vref to the second terminal of the light emission control module 120.

The compensation module 130 is configured to, during the first reset stage, turn on in response to a first scan signal on the first scan line S1 to transmit the reset voltage to the control terminal of the driving module 110.

The first power line V1 is configured to, during the first reset stage, transmit a first power voltage to the first terminal of the driving module 110.

The second power line V2 is configured to, during the first reset stage, transmit a second power voltage to the second terminal of the light emitting device D1.

The reset module 140 transmits a reset voltage to the first terminal of the light emitting device D1 during the first reset stage to reset the first terminal of the light emitting device D1. Moreover, during the first reset stage, a voltage of the second terminal of the light emitting device D1 is the second power voltage, which can ensure that the light emitting device D1 does not emit light during the first reset stage. Furthermore, during the first reset stage, the compensation module 130 is turned on, and can transmit the reset voltage to the control terminal of the driving module 110 to reset the control terminal of the driving module 110.

Moreover, during the first reset stage, the light emission control module 120 is not turned on, which can avoid a situation where the driving module 110 generates a driving current and the light emitting device D1 emits light erroneously due to a large voltage difference between the first terminal of the driving module 110 and the control terminal of the driving module 110.

In one embodiment, the first power voltage is greater than the reset voltage. For example, a voltage difference of the reset voltage minus the first power voltage is smaller than a threshold voltage of a transistor in the driving module 110, and an absolute value of a voltage difference between the first terminal of the driving module 110 and the control terminal of the driving module 110 is relatively large, causing the driving module 110 to turn on. Moreover, the absolute value of a voltage difference between the first terminal of the driving module 110 and the control terminal of the driving module 110 is relatively large, a turn-on degree of the driving module 110 is large, and a current generated by the driving module 110 is large, which can more quickly and more fully discharge a residual charge of the control terminal of the driving module 110, can better eliminate or neutralize a residual voltage from a previous frame, avoid an influence of a voltage of the control terminal of the driving module 110 from the previous frame when the driving module 110 generates a driving current during a light emission stage, can improve an afterimage, and can improve a brightness of a first frame after switching a screen.

Moreover, by providing the light emission control module 120 between the second terminal of the driving module 110 and the first terminal of the light emitting device D1, it can be ensured that the light emitting device D1 does not emit light when the first power voltage is transmitted to the first terminal of the driving module 110 during the first reset stage. In one embodiment, it is ensured that the absolute value of a voltage difference between the first terminal of the driving module 110 and the control terminal of the driving module 110 is relatively large during the first reset stage, thereby more fully resetting the control terminal of the driving module 110 and better improving the afterimage.

In one embodiment, the compensation module 130 is configured to, at least during a data writing stage, turn on in response to a first scan signal on the first scan line S1; the light emission control module 120 is configured to, during the data writing stage and a light emission stage, turn on in response to a light emission control signal on the light emission control line EM.

The reset module 140 is further configured to, during a second reset stage, turn on in response to a second scan signal on the second scan line S2 to transmit the reset voltage to the first terminal of the light emitting device D1.

The first reset stage is before the data writing stage, the second reset stage is after the data writing stage, and the light emission stage is after the second reset stage.

During the first reset stage, the reset module 140 transmits a reset voltage to the control terminal of the driving module 110 to reset the control terminal of the driving module 110 and cause the driving module 110 to turn on. Thus, it facilitates a subsequent charging or discharging of the control terminal of the driving module 110 by a data voltage through the driving module 110, the light emission control module 120, and a compensation module 120 during a data writing stage, to achieve a threshold compensation of the driving module 110. Since the light emission control module 120 is turned on during the data writing stage, which changes a voltage of the first terminal of the light emitting device D1, the reset module 140 again transmits the reset voltage to the first terminal of the light emitting device D1 during a second reset stage to clear a residual charge of the first terminal of the light emitting device D1 during the data writing stage, avoiding an impact on a light emission brightness of the light emitting device D1 during a light emission stage, which can further improve display effects of a display panel. Moreover, it ensures that the light emitting device D1 is in a black state before light emission. Furthermore, a good reset effect is achieved, and the light emitting device D1 can emit light better, which is beneficial to improving a display contrast of the display panel.

In one embodiment, the compensation module 130 is configured to, at least during a data writing stage, turn on in response to a first scan signal on the first scan line S1.

The reset module 140 is further configured to, during a redundant stage, turn off in response to a second scan signal. In one embodiment, the redundant stage is between the first reset stage and the data writing stage.

The compensation module 130 is further configured to, during the redundant stage, turn off in response to the first scan signal, and the light emission control module 120 is further configured to, during the redundant stage, turn off in response to a light emission control signal.

In one embodiment, by providing a redundant stage before the data writing stage, a more sufficient reset can be ensured, avoiding a situation where some pixel circuits enter the data writing stage without completing the reset, that is, avoiding an impact of a reset delay on a data writing, which is beneficial to ensuring a reset effect and an accuracy of the data writing.

In one embodiment, the second power line V2 is further configured to, during a second reset stage, transmit a third power voltage to the second terminal of the light emitting device D1. In one embodiment, a voltage on the second power line V2 changes in advance before a light emission stage, avoiding a large voltage change on the second power line V2 during the light emission stage, which would cause a large voltage fluctuation of the first terminal of the light emitting device D1, thereby affecting a light emission brightness of the light emitting device D1 during the light emission stage.

In one embodiment, as shown in FIG. 3, the pixel circuit further includes a storage module 150.

A first terminal of the storage module 150 is connected to a third power line V3. A second terminal of the storage module 150 is connected to the control terminal of the driving module 110. The storage module 150 is configured to maintain a potential of the control terminal of the driving module 110.

The third power line V3 can provide a first power voltage to the first terminal of the storage module 150. The first terminal of the storage module 150 is connected to the third power line V3, and a potential of the first terminal of the storage module 150 is a fixed potential. Since a charge stored by the storage module 150 is unchanged, a potential of the second terminal of the storage module 150 can be maintained, that is, a potential of the control terminal of the driving module 110 is maintained.

Moreover, the pixel circuit includes a driving module 110, a light emission control module 120, a compensation module 130, a reset module 140, and a storage module 150. The number of devices in the pixel circuit is small, and a display panel can achieve a large pixel density, and a spacing between devices does not need to be excessively small, which can reduce a crosstalk.

Exemplarily, FIG. 4 is a driving timing diagram of a pixel circuit provided by an embodiment of the present application. Hereinafter, a driving process of the pixel circuit will be described with reference to FIGS. 3 and 4.

During a first reset stage t1, the first power line V1 transmits a first power voltage VDD to the first terminal of the driving module 110. The second power line V2 transmits a second power voltage VSS1 to the second terminal of the light emitting device D1. A first scan signal Scan1 on a first scan line S1 is at an active level. The compensation module 130 is turned on. A second scan signal Scan2 on a second scan line S2 is at an active level. The reset module 140 is turned on. A light emission control signal Em on a light emission control line EM is at an inactive level. The light emission control module 120 is not turned on. The reset module 140 transmits a reset voltage Vr on a reset signal line Vref to the first terminal of the light emitting device D1 to reset the first terminal of the light emitting device D1. The compensation module 130 transmits the reset voltage Vr to the control terminal of the driving module 110 to reset the control terminal of the driving module 110. A voltage of the first terminal of the driving module 110 is the first power voltage VDD, and an absolute value of a voltage difference Vr-VDD between a voltage of the control terminal of the driving module 110 and a voltage of the first terminal of the driving module 110 is relatively large, and the driving module 110 is turned on. Moreover, a turn-on degree of the driving module 110 is large, and a current of the driving module 110 is large, which can better and faster discharge a residual charge of the control terminal of the driving module 110, making a reset more sufficient.

A voltage difference between the reset voltage and the second power voltage VSS1 is smaller than a turn-on voltage of the light emitting device D1, and the light emitting device D1 does not emit light.

FIG. 4 shows a case where an active level of the first scan signal Scan1 is a high level, an active level of the second scan signal Scan2 is a high level, and an inactive level of the light emission control signal Em is a high level, but this is not limiting.

During a redundant stage t2, the first power line V1 transmits the first power voltage VDD to the first terminal of the driving module 110, and the second power line V2 transmits the second power voltage VSS1 to the second terminal of the light emitting device D1. The first scan signal Scan1 on the first scan line S1 is at an inactive level, and the compensation module 130 is not turned on. The second scan signal Scan2 on the second scan line S2 is at an inactive level, and the reset module 140 is not turned on. The light emission control signal Em on the light emission control line EM is at an inactive level, and the light emission control module 120 is not turned on. A redundant time is left for a transmission of the reset voltage to avoid an impact of a reset delay on a data writing.

During a data writing stage t3, the first power line V1 transmits a data voltage Vdata to the first terminal of the driving module 110, and the second power line V2 transmits the second power voltage VSS1 to the second terminal of the light emitting device D1. The first scan signal Scan1 on the first scan line S1 is at an active level, and the compensation module 130 is turned on. The second scan signal Scan2 on the second scan line S2 is at an inactive level, and the reset module 140 is not turned on. The light emission control signal Em on the light emission control line EM is at an active level, and the light emission control module 120 is turned on. This causes the data voltage Vdata to charge or discharge the second terminal of the storage module 150 through the driving module 110, the light emission control module 120, and the compensation module 130, that is, to charge or discharge the control terminal of the driving module 110, until a voltage of the control terminal of the driving module 110 becomes Vdata+Vth, and the driving module 110 is turned off. In one embodiment, Vth is a threshold voltage of a transistor in the driving module 110. In one embodiment, a data writing and a threshold compensation are achieved.

During a second reset stage t4, the first power line V1 transmits the first power voltage VDD to the first terminal of the driving module 110. The second power line V2 transmits a third power voltage VSS2 to the second terminal of the light emitting device D1. The first scan signal Scan1 on the first scan line S1 is at an inactive level, and the compensation module 130 is not turned on. The second scan signal Scan2 on the second scan line S2 is at an active level, and the reset module 140 is turned on. The light emission control signal Em on the light emission control line EM is at an inactive level, and the light emission control module 120 is not turned on. The reset module 140 again transmits the reset voltage to the first terminal of the light emitting device D1 to clear a residual charge of the first terminal of the light emitting device D1 during the data writing stage, avoiding an impact on a light emission brightness of the light emitting device D1 during a light emission stage. A voltage on the second power line V2 changes in advance before the light emission stage, avoiding a large voltage change on the second power line V2 during the light emission stage, which would cause a large voltage fluctuation of the first terminal of the light emitting device D1, thereby affecting the light emission brightness of the light emitting device D1 during the light emission stage.

Moreover, the second reset module 140 can maintain a potential of the first terminal of the light emitting device D1, avoiding a parasitic capacitance of the light emitting device D1 from coupling and transmitting the third power voltage VSS2 to the first terminal of the light emitting device D1, and can avoid the potential of the first terminal of the light emitting device D1 being affected by a voltage change on the second power line V2.

During a light emission stage t5, the first power line V1 transmits the first power voltage VDD to the first terminal of the driving module 110. The second power line V2 transmits the third power voltage VSS2 to the second terminal of the light emitting device D1. The first scan signal Scan1 on the first scan line S1 is at an inactive level, and the compensation module 130 is not turned on. The second scan signal Scan2 on the second scan line S2 is at an inactive level, and the reset module 140 is not turned on. The light emission control signal Em on the light emission control line EM is at an active level, and the light emission control module 120 is turned on. This causes the first power line V1, the driving module 110, the light emission control module 120, the light emitting device D1, and the second power line V2 to form a current path, and the driving module 110 can generate a driving current to drive the light emitting device D1 to emit light.

A driving current I generated by the driving module 110 is I=1/2×(W/L)μCox×(Vgs−Vth)². In one embodiment, Vgs is a voltage difference between the control terminal of the driving module 110 and the first terminal of the driving module 110, so Vgs is Vdata+Vth−VDD, and thus I=1/2×(W/L)μCox×(VDD−Vdata)². In one embodiment, W is a channel width of a transistor in the driving module 110, L is a channel length of a transistor in the driving module 110, u is an electron mobility of a transistor in the driving module 110, and Cox is a unit area channel capacitance of a transistor in the driving module 110. Therefore, the driving current is independent of a threshold voltage of a transistor in the driving module 110, avoiding a fluctuation of the driving current caused by a threshold voltage change. Moreover, a problem where different driving modules 110 have different threshold voltages of transistors, leading to poor display uniformity of a display panel, is avoided.

In some embodiments, the second scan signal Scan2 is a global signal. The second power voltage VSS1 and the third power voltage VSS2 are global signals.

That is, all pixel circuits in a display panel are connected to a same second scan signal, and all pixel circuits simultaneously execute a first reset stage, and all pixel circuits simultaneously execute a second reset stage, which can reduce the number of gate driving circuits for generating the second scan signal, and is beneficial to achieving a narrow bezel of the display panel. All pixel circuits in the display panel are simultaneously connected to the second power voltage and simultaneously connected to the third power voltage. All pixel circuits in the display panel may be connected to a same second power line V2, which can reduce the number of power lines, is beneficial to improving a pixel density of the display panel, and reduces a crosstalk between traces.

In one embodiment, a first terminal of the reset module 140 is connected to the reset signal line Vref, and a second terminal of the reset module 140 is connected to the second terminal of the light emission control module 120. A second control terminal of the reset module 140 is connected to the reset signal line Vref. In one embodiment, a voltage of the second control terminal of the reset module 140 is the same as a voltage of the first terminal of the reset module 140, that is, a voltage difference between the second control terminal of the reset module 140 and the first terminal of the reset module 140 remains unchanged, which can maintain a voltage of the second control terminal of the reset module 140, and a state of the reset module 140 is not affected by a change in a voltage difference between the second control terminal of the reset module 140 and the first terminal of the reset module 140, which can ensure that a turn-on and a turn-off of the reset module 140 are controlled by the second scan signal.

Based on the above embodiments, possible structures of various modules in the pixel circuit will be described below, but this is not intended to limit the present application.

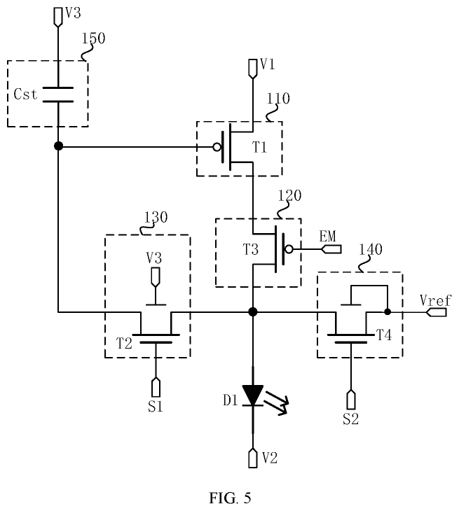

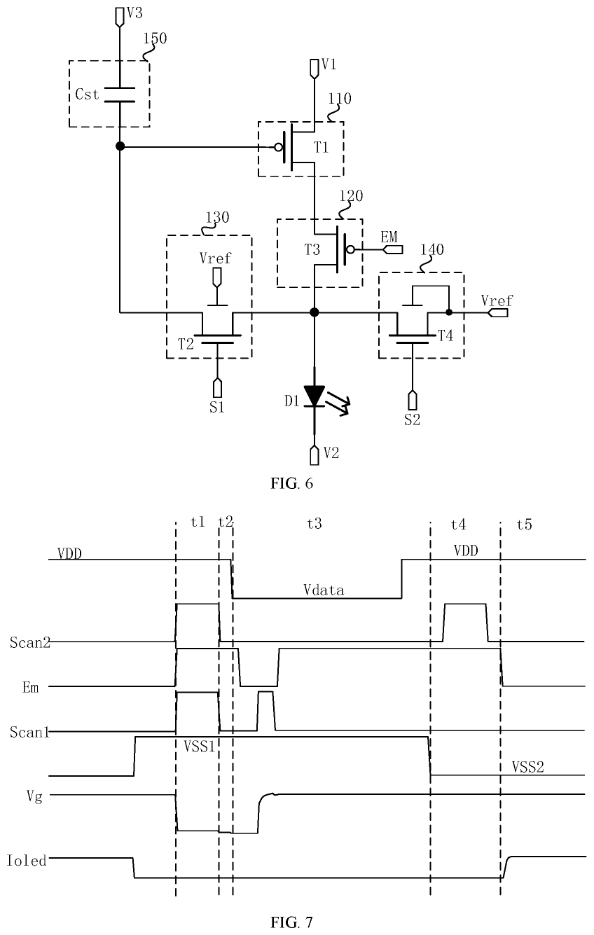

FIG. 5 is a structural schematic diagram of yet another pixel circuit provided by an embodiment of the present application, and FIG. 6 is a structural schematic diagram of yet another pixel circuit provided by an embodiment of the present application. In one embodiment, referring to FIG. 5 or FIG. 6, the driving module 110 includes a driving transistor T1.

A first electrode of the driving transistor T1 is connected to the first power line V1. A second electrode of the driving transistor T1 is connected to a first terminal of the light emission control module 120. A gate of the driving transistor T1 is connected to the compensation module 130.

The compensation module 130 includes a compensation transistor T2.

The compensation transistor T2 is connected between the second terminal of the light emission control module 120 and a control terminal of the driving module 110.

The light emission control module 120 includes a light emission control transistor T3.

A first electrode of the light emission control transistor T3 is connected to a second terminal of the driving module 110. A second electrode of the light emission control transistor T3 is connected to a first terminal of the light emitting device D1. A gate of the light emission control transistor T3 is connected to a light emission control line.

The reset module 140 includes a reset transistor T4. The reset transistor T4 is connected between a reset signal line Vref and the second terminal of the light emission control module 120. A first gate of the reset transistor T4 is connected to a second scan line S2. A second gate of the reset transistor T4 is connected to the reset signal line Vref.

A type of the reset transistor T4 is different from a type of at least one of the driving transistor T1, the light emission control transistor T3, and the compensation transistor T2.

In one embodiment, the first electrode of the driving transistor T1 is a source and the second electrode of the driving transistor T1 is a drain, or, the first electrode of the driving transistor T1 is a drain and the second electrode of the driving transistor T1 is a source, which is not limited herein. The first electrode of the light emission control transistor T3 is a source and the second electrode of the light emission control transistor T3 is a drain, or, the first electrode of the light emission control transistor T3 is a drain and the second electrode of the light emission control transistor T3 is a source, which is not limited herein.

In one embodiment, when the light emission control transistor T3 is turned on and a second power line V2 transmits a third power voltage VSS2, the driving transistor T1 may generate a driving current to drive the light emitting device D1 to emit light. The reset transistor T4 may transmit a reset voltage to the first terminal of the light emitting device D1 during a first reset stage and a second reset stage to reset the first terminal of the light emitting device D1. The compensation transistor T2 may turn on during the first reset stage to transmit the reset voltage to the gate of the driving transistor T1 to reset the gate of the driving transistor T1. During a data writing stage, the driving transistor T1, the compensation transistor T2, and the light emission control transistor T3 are turned on, and a data voltage Vdata charges a second terminal of a storage module 150 through the driving transistor T1, the compensation transistor T2, and the light emission control transistor T3, until a voltage of the gate of the driving transistor T1 becomes Vdata+Vth, and the driving transistor T1 is turned off, achieving a data writing and a threshold compensation. In one embodiment, Vth is a threshold voltage of the driving transistor T1.

By configuring a type of the reset transistor T4 to be different from a type of at least one of the driving transistor T1, the light emission control transistor T3, and the compensation transistor T2, the pixel circuit may include two types of transistors. Different types of transistors have different types of active layers, and different types of active layers may be stacked along a thickness direction of a display panel, and different types of transistors may be stacked, which is beneficial to improving a pixel density of the display panel. Moreover, after transistors are stacked, some signal lines (such as the second scan line S2 and the light emission control line EM) may be stacked, which may reduce a crosstalk between signals. Furthermore, after transistors are stacked, distances between the transistors and some traces are large, which may reduce a crosstalk between devices and the traces. For example, the second scan line S2 corresponding to the reset transistor T4 and the light emission control line EM corresponding to the light emission control transistor T3 are stacked with a large distance, which may reduce a crosstalk between the second scan line S2 and the light emission control line EM, and reduce a crosstalk between the light emission control transistor T3 and the second scan line S2. For example, if the light emission control line EM, the second scan line S2, and the first power line V1 are sequentially stacked, a crosstalk between the light emission control transistor T3 and the first power line V1, and a crosstalk between the light emission control line EM and the first power line V1 can also be reduced.

In one embodiment, referring to FIG. 5 or FIG. 6, the reset transistor T4 is an oxide transistor, and the driving transistor T1 is a polysilicon transistor. In one embodiment, a leakage current of the reset transistor T4 is small, and the reset transistor T4 may be stacked with the driving transistor T1. The light emission control transistor T3 may be a polysilicon transistor or an oxide transistor, which is not limited herein. The compensation transistor T2 may be an oxide transistor or a polysilicon transistor, which is not limited herein.

In one embodiment, referring to FIG. 5 or FIG. 6, the light emission control transistor T3 is a polysilicon transistor, and the compensation transistor T2 is an oxide transistor. In one embodiment, one pixel circuit includes two polysilicon transistors and two oxide transistors, and when stacked, areas of transistors provided in different film layers are close, which is beneficial to improving a pixel density of a display panel.

In one embodiment, referring to FIG. 5 or FIG. 6, the storage module 150 includes a storage capacitor Cst;

A first electrode of the storage capacitor Cst is connected to a third power line V3, and a second electrode of the storage capacitor Cst is connected to the control terminal of the driving module 110. A capacitance of the storage capacitor Cst is unchanged, and a voltage stored by the storage capacitor Cst is unchanged. The first electrode of the storage capacitor Cst is connected to the third power line V3 with a fixed voltage, thereby maintaining a voltage of the second electrode of the storage capacitor Cst, that is, maintaining a voltage of the control terminal of the driving module 110, which can ensure a stability of a driving current, enable the light emitting device D1 to emit light stably, improves display effects of a display panel, and thus improves a use performance of the display panel.

FIG. 7 is a simulation timing diagram provided by an embodiment of the present application. As shown in FIGS. 5 and 7, a driving process of a pixel circuit includes the following stages.

During a first reset stage t1, a first power line V1 transmits a first power voltage VDD to a first electrode of a driving transistor T1, and a second power line V2 transmits a second power voltage VSS1 to a second terminal of a light emitting device D1. A first scan signal Scan1 on a first scan line S1 is at an active level, and a compensation transistor T2 is turned on. A second scan signal Scan2 on a second scan line S2 is at an active level, and a reset transistor T4 is turned on. A light emission control signal Em on a light emission control line EM is at an inactive level, and a light emission control transistor T3 is not turned on. The reset transistor T4 transmits a reset voltage Vr on a reset signal line Vref to a first terminal of the light emitting device D1 to reset the first terminal of the light emitting device D1. The compensation transistor T2 transmits the reset voltage Vr to a gate of the driving transistor T1 to reset the gate of the driving transistor T1, and a voltage Vg of the gate of the driving transistor T1 is the reset voltage, which is a relatively low voltage. A voltage of the first electrode of the driving transistor T1 is the first power voltage VDD, and an absolute value of a voltage difference Vr-VDD between a voltage of the gate of the driving transistor T1 and a voltage of the first electrode of the driving transistor T1 is relatively large, the driving transistor T1 is turned on, and a turn-on degree of the driving transistor T1 is large. A current of the driving transistor T1 is large, which can better and faster discharge a residual charge of the gate of the driving transistor T1, making a reset more sufficient. Since the light emission control transistor T3 is not turned on, a current Ioled of the light emitting device D1 is zero.

A voltage difference between the reset voltage and the second power voltage VSS1 is smaller than a turn-on voltage of the light emitting device D1, the light emitting device D1 does not emit light, ensuring that a current Ioled of the light emitting device D1 is zero.

FIG. 4 shows a case where an active level of the first scan signal Scan1 is a high level, an active level of the second scan signal Scan2 is a high level, and an inactive level of the light emission control signal Em is a high level, but this is not limiting.

During a redundant stage t2, the first power line V1 transmits the first power voltage VDD to the first electrode of the driving transistor T1, and the second power line V2 transmits the second power voltage VSS1 to the second terminal of the light emitting device D1. The first scan signal Scan1 on the first scan line S1 is at an inactive level, and the compensation transistor T2 is not turned on. The second scan signal Scan2 on the second scan line S2 is at an inactive level, and the reset transistor T4 is not turned on. The light emission control signal Em on the light emission control line EM is at an inactive level, and the light emission control transistor T3 is not turned on. A redundant time is left for a transmission of the reset voltage to avoid an impact of a reset delay on a data writing.

During a data writing stage t3, the first power line V1 transmits a data voltage Vdata to the first electrode of the driving transistor T1. The second power line V2 transmits the second power voltage VSS1 to the second terminal of the light emitting device D1. The first scan signal Scan1 on the first scan line S1 is at an active level, and the compensation transistor T2 is turned on. The second scan signal Scan2 on the second scan line S2 is at an inactive level, and the reset transistor T4 is not turned on. The light emission control signal Em on the light emission control line EM is at an active level, and the light emission control transistor T3 is turned on. This causes the data voltage Vdata to charge or discharge a second electrode of a storage capacitor Cst through the driving transistor T1, the light emission control transistor T3, and the compensation transistor T2, that is, to charge or discharge the gate of the driving transistor T1, until a voltage Vg of the gate of the driving transistor T1 becomes Vdata+Vth, and the driving transistor T1 is turned off. In one embodiment, Vth is a threshold voltage of the driving transistor T1. In one embodiment, a data writing and a threshold compensation are achieved.

Since a voltage of the second terminal of the light emitting device D1 is the relatively large second power voltage VSS1, a voltage difference between a voltage of the first terminal of the light emitting device D1 and the second power voltage VSS1 is smaller than a turn-on voltage of the light emitting device D1, the light emitting device D1 does not emit light, ensuring that a current Ioled of the light emitting device D1 is zero.

During a second reset stage t4, the first power line V1 transmits the first power voltage VDD to the first electrode of the driving transistor T1, and the second power line V2 transmits a third power voltage VSS2 to the second terminal of the light emitting device D1. The first scan signal Scan1 on the first scan line S1 is at an inactive level, and the compensation transistor T2 is not turned on. The second scan signal Scan2 on the second scan line S2 is at an active level, and the reset transistor T4 is turned on. The light emission control signal Em on the light emission control line EM is at an inactive level, and the light emission control transistor T3 is not turned on. The reset transistor T4 again transmits the reset voltage to the first terminal of the light emitting device D1 to clear a residual charge of the first terminal of the light emitting device D1 during the data writing stage, avoiding an impact on a light emission brightness of the light emitting device D1 during a light emission stage. A voltage on the second power line V2 changes in advance before the light emission stage, avoiding a large voltage change on the second power line V2 during the light emission stage, which would cause a large voltage fluctuation of the first terminal of the light emitting device D1, thereby affecting the light emission brightness of the light emitting device D1 during the light emission stage.

Moreover, a second reset transistor T4 can maintain a potential of the first terminal of the light emitting device D1, avoiding a parasitic capacitance of the light emitting device D1 from coupling and transmitting the third power voltage VSS2 to the first terminal of the light emitting device D1, and can avoid the potential of the first terminal of the light emitting device D1 being affected by a voltage change on the second power line V2. A voltage difference between the reset voltage and the third power voltage VSS2 is smaller than a conduction voltage (turn-on voltage) of the light emitting device D1, and a current Ioled of the light emitting device D1 is zero.

During a light emission stage t5, the first power line V1 transmits the first power voltage VDD to the first electrode of the driving transistor T1, and the second power line V2 transmits the third power voltage VSS2 to the second terminal of the light emitting device D1. The first scan signal Scan1 on the first scan line S1 is at an inactive level, and the compensation transistor T2 is not turned on. The second scan signal Scan2 on the second scan line S2 is at an inactive level, and the reset transistor T4 is not turned on. The light emission control signal Em on the light emission control line EM is at an active level, and the light emission control transistor T3 is turned on. This causes the first power line V1, the driving transistor T1, the light emission control transistor T3, the light emitting device D1, and the second power line V2 to form a current path, and the driving transistor T1 can generate a driving current to drive the light emitting device D1 to emit light. A driving current I generated by the driving transistor T1 is I=1/2×(W/L)μCox×(Vgs−Vth)². In one embodiment, Vgs is a voltage difference between a gate of the driving transistor T1 and the first electrode of the driving transistor T1, so Vgs is Vdata+Vth−VDD, and thus I=1/2×(W/L)μCox×(VDD−Vdata)². In one embodiment, W is a channel width of the driving transistor T1, L is a channel length of the driving transistor T1, u is an electron mobility of the driving transistor T1, and Cox is a unit area channel capacitance of the driving transistor T1. Therefore, the driving current is independent of a threshold voltage of the driving transistor T1, avoiding a fluctuation of the driving current caused by a threshold voltage change. Moreover, a problem where different driving transistors T1 have different threshold voltages, leading to poor display uniformity of a display panel, is avoided. A current Ioled of the light emitting device D1 is the same as the driving current I, the current Ioled of the light emitting device D1 is greater than zero, and the light emitting device D1 emits light.

In some embodiments, referring to FIG. 5, a second control terminal of the compensation module 130 is connected to a third power line V3, and the third power line V3 is configured to transmit the first power voltage VDD to the second control terminal of the compensation module 130;

An absolute value of a first voltage corresponding to an active level of the second scan signal Scan2 is smaller than an absolute value of a second voltage corresponding to an inactive level of the second scan signal Scan2.

In one embodiment, for example, an active level of the second scan signal Scan2 is a high level and an inactive level of the second scan signal Scan2 is a low level, then the first voltage is a positive voltage and the second voltage is a negative voltage. The first power voltage VDD is a positive voltage.

In one embodiment, the first power voltage VDD is a positive voltage, that is, a voltage of the second control terminal of the compensation module 130 is a positive voltage. By configuring an absolute value of a first voltage corresponding to an active level of the second scan signal Scan2 to be smaller than an absolute value of a second voltage corresponding to an inactive level of the second scan signal Scan2, an absolute value of the second voltage corresponding to the inactive level of the second scan signal Scan2 is relatively large, which can ensure that the compensation module 130 can be turned off well when the second scan signal Scan2 is at the inactive level.

In another embodiment, referring to FIG. 6, a second control terminal of the compensation module 130 is connected to a reset signal line Vref.

An absolute value of a first voltage corresponding to an active level of the second scan signal Scan2 is greater than an absolute value of a second voltage corresponding to an inactive level of the second scan signal Scan2.

In one embodiment, for example, an active level of the second scan signal Scan2 is a high level and an inactive level of the second scan signal Scan2 is a low level, then the first voltage is a positive voltage and the second voltage is a negative voltage. A reset voltage on the reset signal line Vref is a negative voltage.

In one embodiment, a reset voltage on the reset signal line Vref is a negative voltage, that is, a voltage of the second control terminal of the compensation module 130 is a negative voltage. By configuring an absolute value of a first voltage corresponding to an active level of the second scan signal Scan2 to be greater than an absolute value of a second voltage corresponding to an inactive level of the second scan signal Scan2, an absolute value of the first voltage corresponding to the active level of the second scan signal Scan2 is relatively large, which can ensure that the compensation module 130 can be turned on well when the second scan signal Scan2 is at the active level.

In one embodiment, the compensation module 130 includes a compensation transistor T2, and the compensation transistor T2 is connected between the second terminal of the light emission control module 120 and a control terminal of the driving module 110. A first gate of the compensation transistor T2 serves as a first control terminal of the compensation module 130, and a second gate of the compensation transistor T2 serves as a second control terminal of the compensation module 130.

For example, the first gate of the compensation transistor T2 is a top gate of the compensation transistor T2, and the second gate of the compensation transistor T2 is a bottom gate of the compensation transistor T2. When the second gate of the compensation transistor T2 is connected to the third power line V3, a positive voltage accumulation electric field at the bottom gate of the compensation transistor T2 will spontaneously induce a conductive channel, and the top gate of the compensation transistor T2 must provide a sufficiently strong reverse depletion electric field to cancel an accumulation effect through an electric field superposition, forcing channel carriers to be completely depleted, ultimately achieving a reliable turn-off of the compensation transistor T2. Therefore, by configuring an absolute value of a first voltage corresponding to an active level of the second scan signal Scan2 to be smaller than an absolute value of a second voltage corresponding to an inactive level of the second scan signal Scan2, an absolute value of the second voltage corresponding to the inactive level of the second scan signal Scan2 is relatively large, which can ensure that the compensation transistor T2 can be turned off well when the second scan signal Scan2 is at the inactive level.

When the second gate of the compensation transistor T2 is connected to the reset signal line Vref, a negative voltage depletion electric field at the bottom gate of the compensation transistor T2 will spontaneously suppress a channel conduction, and the top gate of the compensation transistor T2 must provide a sufficiently strong accumulation electric field to cancel a depletion effect through an electric field superposition, forcibly accumulating carriers to form a conductive channel, ensuring a turn-on of the compensation transistor T2. Therefore, by configuring an absolute value of a first voltage corresponding to an active level of the second scan signal Scan2 to be greater than an absolute value of a second voltage corresponding to an inactive level of the second scan signal Scan2, an absolute value of the first voltage corresponding to the active level of the second scan signal Scan2 is relatively large, which can ensure that the compensation transistor T2 can be turned on well when the second scan signal Scan2 is at the active level.

In one embodiment, a reset voltage on a reset signal line Vref is a DC (Direct Current) voltage. That is, the reset voltage is a fixed voltage, which can reduce a voltage change and is beneficial to reducing a power consumption of a chip generating the reset voltage. In another embodiment, a reset voltage on a reset signal line Vref is an AC (Alternating Current) voltage, and the reset voltage includes a first sub-voltage and a second sub-voltage.

When a voltage transmitted by a second power line V2 to a second terminal of a light emitting device D1 transitions from a second power voltage VSS1 to a third power voltage VSS2, a voltage on the reset signal line Vref transitions from the first sub-voltage to the second sub-voltage; and the second sub-voltage is smaller than the first sub-voltage.

In one embodiment, a reset voltage on the reset signal line Vref is an AC voltage, that is, a reset voltage on the reset signal line Vref is variable. The reset voltage may change following a change in a voltage on the second power line V2. During a second reset stage, a reset module 140 is turned on to transmit the reset voltage to a first terminal of the light emitting device D1. During the second reset stage, a voltage transmitted by the second power line V2 to the second terminal of the light emitting device D1 transitions from the second power voltage VSS1 to the third power voltage VSS2. The third power voltage VSS2 is smaller, and a voltage on the reset signal line Vref transitions from the first sub-voltage to a smaller second sub-voltage, which can make a voltage difference between the first terminal of the light emitting device D1 and the second terminal of the light emitting device D1 small, avoiding the light emitting device D1 from emitting light during the second reset stage.

In some embodiments, a first sub-voltage is greater than a second power voltage VSS1, and a second sub-voltage is greater than a third power voltage VSS2.

A voltage difference between the first sub-voltage and the second power voltage VSS1 is the same as a voltage difference between the second sub-voltage and the third power voltage VSS2; or, a voltage difference between the second sub-voltage and a third power voltage is smaller than a voltage difference between the first sub-voltage and the second power voltage.

In one embodiment, by configuring the first sub-voltage to be greater than the second power voltage VSS1 and the second sub-voltage to be greater than the third power voltage VSS2, an excessive reset of a first terminal of a light emitting device D1 is avoided, avoiding a problem of a light emission delay of the light emitting device D1 in a first frame after switching a screen, enabling the light emitting device D1 to turn on better in the first frame.

In one embodiment, a voltage difference between a first sub-voltage and a second power voltage VSS1 (a voltage difference of the first sub-voltage minus the second power voltage VSS1) is the same as a voltage difference between a second sub-voltage and a third power voltage VSS2 (a voltage difference of the second sub-voltage minus the third power voltage VSS2), and a degree of change when a voltage on a second power line V2 transitions is the same as a degree of change when a voltage on a reset signal line Vref transitions, avoiding an impact on a light emitting device D1.

In another embodiment, a voltage difference between a second sub-voltage and a third power voltage is smaller than a voltage difference between a first sub-voltage and a second power voltage. That is, when a voltage on a second power line V2 decreases from a second power voltage VSS1 to a third power voltage VSS2, and a first sub-voltage on a reset signal line Vref decreases to the second sub-voltage, a degree of a voltage reduction on the reset signal line Vref may be relatively large, and a voltage difference across a light emitting device D1 is small during a second reset stage, which can ensure that the light emitting device D1 does not emit light during the second reset stage.

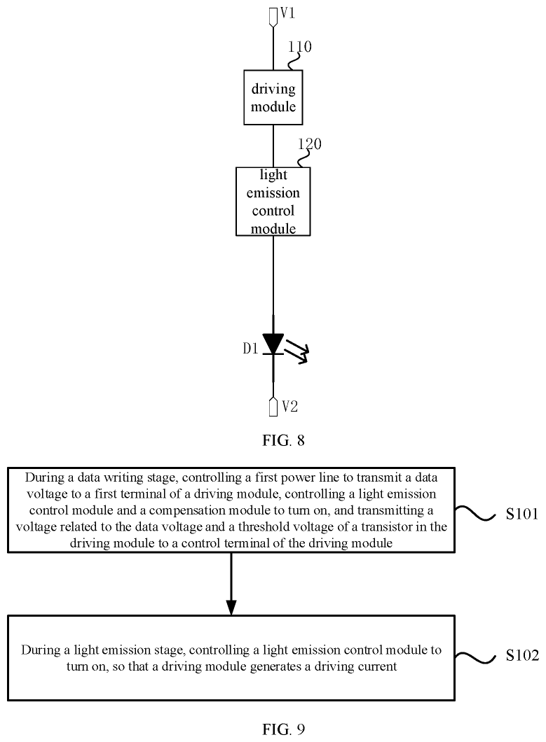

An embodiment of the present application further provides another pixel circuit. FIG. 8 is a structural schematic diagram of yet another pixel circuit provided by an embodiment of the present application. Referring to FIG. 8, the pixel circuit includes a driving module 110 and a light emission control module 120.

A first terminal of the driving module 110 is connected to a first power line V1, and the first power line V1 is configured to transmit a first power voltage and a data voltage to the first terminal of the driving module 110 in a time-division manner.

A first terminal of the light emission control module 120 is connected to a second terminal of the driving module 110. A second terminal of the light emission control module 120 is connected to a first terminal of a light emitting device D1. The light emission control module 120 is configured to control whether a driving module generates a driving current.

A second terminal of the light emitting device D1 is connected to a second power line V2, and the second power line V2 is configured to transmit a second power voltage and a third power voltage to the second terminal of the light emitting device D1 in a time-division manner. In one embodiment, the third power voltage is smaller than the second power voltage.

In one embodiment, by configuring the first power line V1 to transmit a first power voltage and a data voltage to the first terminal of the driving module 110 in a time-division manner, the number of devices may be reduced without needing to provide two transistors to transmit the first power voltage and the data voltage, which is beneficial to reducing an occupied space of the pixel circuit and facilitating achievement of a higher pixel density. Moreover, the pixel circuit includes fewer devices, and spacing between various devices does not need to be excessively small, thereby reducing parasitic capacitance between the various devices and traces, reducing crosstalk between signals, and reducing an impact on a light emission brightness of the light emitting device D1, which is beneficial to improving display effects of a display panel, and thus improving a use performance of the display panel.

Moreover, a second power line V2 transmits a second power voltage and a third power voltage to a second terminal of a light emitting device D1 in a time-division manner, and a light emission of the light emitting device D1 may be controlled by controlling whether a light emission control module 120 is turned on and a voltage of the second terminal of the light emitting device D1. For example, the light emitting device D1 may emit light only when the light emission control module 120 is turned on and a voltage of the second terminal of the light emitting device D1 is a third power voltage. Thus, only one light emission control module 120 is needed without providing two light emission control modules, which may reduce the number of devices in a pixel circuit and facilitate improving a pixel density of a display panel.

In some embodiments, referring to FIG. 3, the pixel circuit further includes a compensation module 130, a reset module 140, and a storage module 150.

The compensation module 130 is connected between a second terminal of a light emission control module 120 and a control terminal of a driving module 110. The compensation module 130 is configured to, when turned on, transmit a voltage related to a data voltage and a threshold voltage of a transistor in the driving module to the control terminal of the driving module 110.

The reset module 140 is connected between a reset signal line Vref and the second terminal of the light emission control module 120. A control terminal of the reset module 140 is connected to a second scan line S2. The reset module 140 is configured to, during a first reset stage, turn on in response to a second scan signal on the second scan line S2 to transmit a reset voltage on the reset signal line Vref to the second terminal of the light emission control module 120.

A first terminal of the storage module 150 is connected to a third power line V3. A second terminal of the storage module 150 is connected to the control terminal of the driving module 110. The storage module 150 is configured to maintain a potential of the control terminal of the driving module 110.

A structure of the pixel circuit provided in this embodiment is the same as a structure of the pixel circuit shown in FIG. 3, and has the same beneficial effects, which will not be described in detail here.

Other structures of the pixel circuit are shown in FIGS. 2, 5 and 6, which will not be described in detail here.

An embodiment of the present application further provides a driving method for a pixel circuit. As shown in FIG. 1, the pixel circuit includes a driving module 110, a light emission control module 120, and a compensation module 130. A first terminal of the driving module 110 is connected to a first power line V1. A first terminal of the light emission control module 120 is connected to a second terminal of the driving module 110, and a second terminal of the light emission control module 120 is connected to a first terminal of a light emitting device D1. The compensation module 130 is connected between the second terminal of the light emission control module 120 and a control terminal of the driving module 110.

FIG. 9 is a flowchart of a driving method for a pixel circuit provided by an embodiment of the present application. Referring to FIG. 9, the driving method for the pixel circuit includes the following steps.

S101: During a data writing stage, controlling a first power line to transmit a data voltage to a first terminal of a driving module, controlling a light emission control module and a compensation module to turn on, and transmitting a voltage related to the data voltage and a threshold voltage of a transistor in the driving module to a control terminal of the driving module.

In one embodiment, during the data writing stage, a first power line V1 transmits a data voltage Vdata to a first terminal of a driving module 110, and a light emission control module 120 and a compensation module 130 are turned on, and the data voltage Vdata charges or discharges a control terminal of the driving module 110 through the driving module 110, the light emission control module 120, and the compensation module 130, until a voltage of the control terminal of the driving module 110 becomes Vdata+Vth, and the driving module 110 is turned off. In one embodiment, Vth is a threshold voltage of a transistor in the driving module 110. In one embodiment, a data writing and a threshold compensation are achieved.

S102: During a light emission stage, controlling a light emission control module to turn on, to cause a driving module to generate a driving current.

In one embodiment, during the light emission stage, a light emission control module 120 is turned on, and a first power line V1, a driving module 110, the light emission control module 120, and a light emitting device D1 form a current path, enabling the driving module 110 to generate a driving current to drive the light emitting device D1 to emit light.

In some embodiments, a pixel circuit further includes a reset module, and the reset module is connected between a reset signal line and a second terminal of a light emission control module;

Before a data writing stage, a driving method further includes: during a first reset stage, controlling a compensation module and the reset module to turn on, to cause the reset module to transmit a reset voltage on the reset signal line to the second terminal of the light emission control module, and the compensation module to transmit the reset voltage to a control terminal of a driving module.

In one embodiment, during the first reset stage, a compensation module 130 and a reset module 140 are turned on, and a light emission control module 120 is not turned on. The reset module 140 transmits a reset voltage Vr on a reset signal line Vref to a first terminal of a light emitting device D1 to reset the first terminal of the light emitting device D1. The compensation module 130 transmits the reset voltage Vr to a control terminal of a driving module 110 to reset the control terminal of the driving module 110.

In one embodiment, during a first reset stage, a driving method further includes: controlling a first power line to transmit a first power voltage to a first terminal of a driving module.

In one embodiment, during the first reset stage, a first power line V1 transmits a first power voltage VDD to a first terminal of a driving module 110. A voltage of a control terminal of the driving module 110 is a reset voltage. The first power voltage VDD is greater than the reset voltage, and an absolute value of a voltage difference Vr-VDD between a voltage of the control terminal of the driving module 110 and a voltage of the first terminal of the driving module 110 is relatively large, the driving module 110 is turned on, and a turn-on degree of the driving module 110 is large. A current of the driving module 110 is large, which can better and faster discharge a residual charge of the control terminal of the driving module 110, making a reset more sufficient.

In one embodiment, after a data writing stage and before a light emission stage, a driving method further includes: during a second reset stage, controlling a reset module to turn on, to cause the reset module to transmit a reset voltage on a reset signal line to a second terminal of a light emission control module.

In one embodiment, during the second reset stage, a first power line V1 transmits a first power voltage VDD to a first terminal of a driving module 110, a second power line V2 transmits a third power voltage VSS2 to a second terminal of a light emitting device D1, and a reset module 140 is turned on. The reset module 140 again transmits a reset voltage to the first terminal of the light emitting device D1 to clear a residual charge of the first terminal of the light emitting device D1 during a data writing stage, avoiding an impact on a light emission brightness of the light emitting device D1 during a light emission stage. A voltage on the second power line V2 changes in advance before the light emission stage, avoiding a large voltage change on the second power line V2 during the light emission stage, which would cause a large voltage fluctuation of the first terminal of the light emitting device D1, thereby affecting the light emission brightness of the light emitting device D1 during the light emission stage.

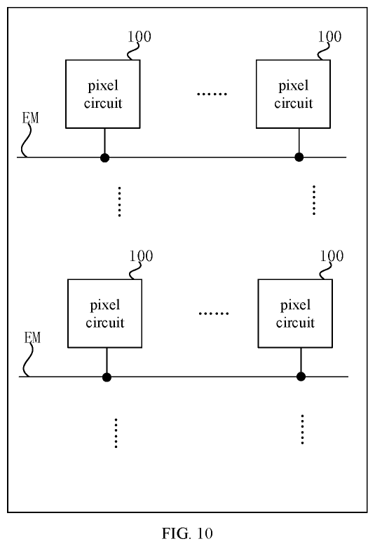

An embodiment of the present application further provides a display panel. FIG. 10 is a structural schematic diagram of a display panel provided by an embodiment of the present application. Referring to FIG. 10, the display panel includes a plurality of pixel circuits 100. The pixel circuit 100 is a pixel circuit provided by any embodiment of the present application. A control terminal of a light emission control module 120 in the pixel circuit 100 is connected to a light emission control line EM. The light emission control module 120 is configured to, during a data writing stage and a light emission stage, turn on in response to an active level of a light emission control signal on the light emission control line EM.

Control terminals of light emission control modules 120 in one row of pixel circuits 100 are connected to a same light emission control line EM.

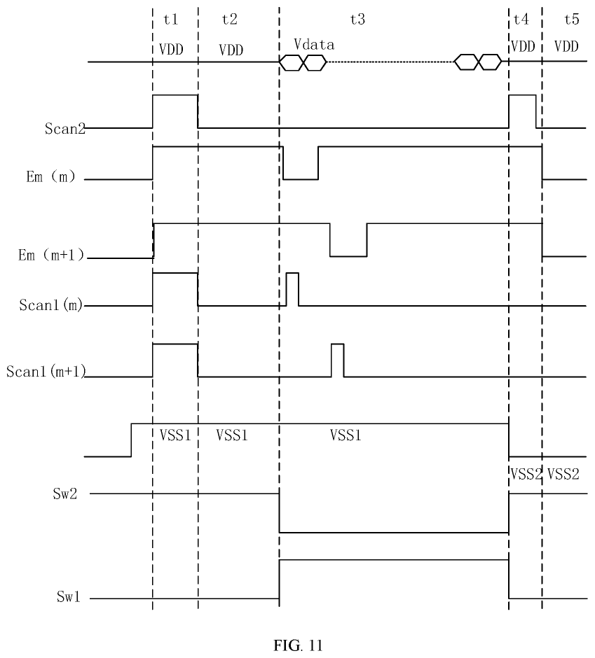

FIG. 11 is a driving timing diagram of a display panel provided by an embodiment of the present application. As shown in FIG. 11, during a data writing stage in one display frame, an active level of a light emission control signal Em(m+1) corresponding to an (m+1)th row of pixel circuits is delayed by one row time relative to an active level of a light emission control signal Em(m) corresponding to an mth row of pixel circuits. In one embodiment, m is a positive integer.

During a light emission stage in the one display frame, light emission control signals corresponding to all pixel circuits 100 simultaneously transition from an inactive level to an active level.

In one embodiment, a display panel includes a plurality of pixel circuits 100, and the plurality of pixel circuits 100 are arranged in an array. FIG. 9 does not show a specific structure of the pixel circuit 100. A specific structure of the pixel circuit 100 is as shown in FIG. 1 or FIG. 7.

In one embodiment, a row time can be determined according to a refresh rate of a display panel and a total number of rows of pixel circuits. For example, one row time is a reciprocal of a refresh rate of the display panel, divided by a total number of rows of pixel circuits.

In one embodiment, during a data writing stage t3 in one display frame, an active level of a light emission control signal Em(m+1) corresponding to an (m+1)th row of pixel circuits is delayed by one row time relative to an active level of a light emission control signal Em(m) corresponding to an mth row of pixel circuits, and after the m^{th} row of pixel circuits completes the data writing stage, the (m+1)th row of pixel circuits performs a data writing, achieving a row-by-row data writing. This enables pixel circuits in a same column and different rows to be connected to a same first power line V1, that is, using one first power line V1 to transmit data voltages to pixel circuits in a same column and different rows in a time-division manner, which can reduce the number of traces. By making light emission control signals corresponding to all pixel circuits 100 simultaneously transition from an inactive level to an active level during a light emission stage t5 in a display frame, all pixel circuits 100 may generate driving currents simultaneously, and all light emitting devices D1 of the display panel may emit light simultaneously. In one embodiment, a row-by-row data writing and a simultaneous light emission are achieved.

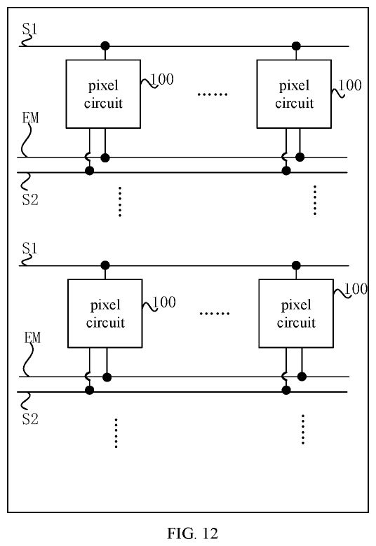

In some embodiments, FIG. 12 is a structural schematic diagram of another display panel provided by an embodiment of the present application. In one embodiment, referring to FIG. 12, a pixel circuit 100 includes a compensation module 130. A first control terminal of the compensation module 130 is connected to a first scan line S1. The compensation module 130 is configured to, during a first reset stage and a data writing stage, turn on in response to an active level of a first scan signal Scan1 on the first scan line S1;

Control terminals of compensation modules 130 in one row of pixel circuits 100 are connected to a same first scan line S1.

As shown in FIG. 11, during a first reset stage t1 in one display frame, first scan signals Scan1 corresponding to all pixel circuits 100 simultaneously transition from an inactive level to an active level, and then, simultaneously transition from an active level to an inactive level;

During a data writing stage t3 in the one display frame, an active level of a first scan signal Scan1(m+1) corresponding to an (m+1)th row of pixel circuits is delayed by one row time relative to an active level of a first scan signal Scan1(m) corresponding to an mth row of pixel circuits.

In one embodiment, during a first reset stage t1 in one display frame, first scan signals Scan1 corresponding to all pixel circuits 100 simultaneously transition from an inactive level to an active level, and then, simultaneously transition from an active level to an inactive level, and all pixel circuits 100 in a display panel simultaneously perform the first reset stage t1. During a data writing stage t3 in the one display frame, an active level of a first scan signal Scan1(m+1) corresponding to an (m+1)th row of pixel circuits is delayed by one row time relative to an active level of a first scan signal Scan1(m) corresponding to an mth row of pixel circuits, and a data writing and a threshold compensation are performed row by row, enabling pixel circuits in a same column and different rows to be connected to a same first power line V1. That is, one first power line V1 is used to transmit data voltages to pixel circuits in a same column and different rows in a time-division manner, which can reduce the number of traces.

In one embodiment, a pixel circuit 100 further includes a reset module 140. The reset module 140 is connected between a reset signal line Vref and a second terminal of a light emission control module 120. A control terminal of the reset module 140 is connected to a second scan line S2. The reset module is configured to, during a first reset stage, turn on in response to a second scan signal on the second scan line to transmit a reset voltage on the reset signal line to the second terminal of the light emission control module.

Control terminals of reset modules 140 in one row of pixel circuits 100 are connected to a same second scan line S2.

During a first reset stage t1 in one display frame, second scan signals Scan2 corresponding to all pixel circuits 100 simultaneously transition from an inactive level to an active level, and then, simultaneously transition from an active level to an inactive level.

In one embodiment, all second scan lines S2 may be connected together. During the first reset stage t1, all pixel circuits 100 simultaneously perform a reset, and a second scan signal Scan2 may be a global signal, which can reduce the number of gate driving circuits for generating the second scan signal, and is beneficial to achieving a narrow bezel of a display panel.

In one embodiment, a reset module 140 is further configured to, during a second reset stage, turn on in response to a second scan signal Scan2 on a second scan line S2.

During a second reset stage t4 in one display frame, second scan signals Scan2 corresponding to all pixel circuits 100 simultaneously transition from an inactive level to an active level, and then, simultaneously transition from an active level to an inactive level.

In one embodiment, during a second reset stage t2, all pixel circuits 100 simultaneously reset a first terminal of a light emitting device D1, which can reduce the number of gate driving circuits for generating a second scan signal, and is beneficial to achieving a narrow bezel of a display panel.

In one embodiment, second terminals of all light emitting devices D1 are connected to a same second power line V2. This can reduce the number of power lines, is beneficial to improving a pixel density of a display panel, and reduces a crosstalk between traces.

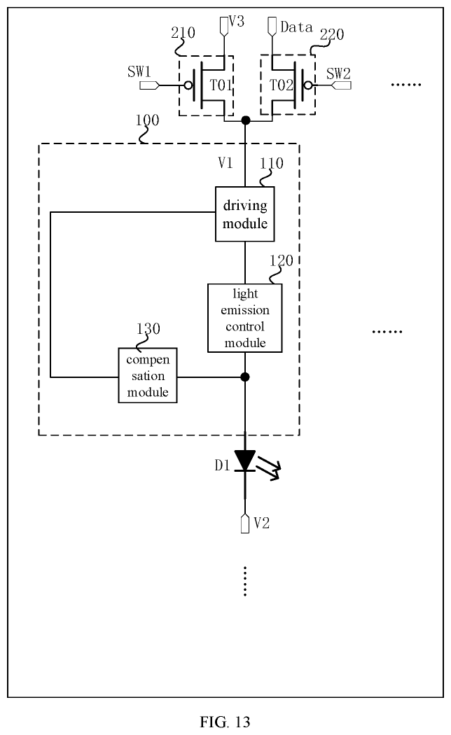

FIG. 13 is a structural schematic diagram of yet another display panel provided by an embodiment of the present application. In one embodiment, referring to FIG. 13, a second control terminal of a compensation module 130 is connected to a reset signal line Vref or a third power line V3.

The display panel further includes a plurality of first switch modules 210 and a plurality of second switch modules 220.

A first switch module 210 is connected between the third power line V3 and a first power line V1. A control terminal of the first switch module 210 is connected to a first switch control line SW1. The first switch module 210 is configured to, during a first reset stage, a light emission stage, and a second reset stage, turn on in response to a first switch control signal on the first switch control line SW1 to transmit a first power voltage on the third power line V3 to the first power line V1.

A second switch module 220 is connected between a data line Data and the first power line V1. A control terminal of the second switch module 220 is connected to a second switch control line SW2. The second switch module 220 is configured to, during a data writing stage, turn on in response to a second switch control signal on the second switch control line SW2 to transmit a data voltage on the data line Data to the first power line V1.

In one embodiment, a first switch module 210 includes a first switch transistor T01, a gate of the first switch transistor T01 serves as a control terminal of the first switch module 210, and the first switch transistor T01 is connected between a third power line V3 and a first power line V1. A second switch module 220 includes a second switch transistor T02, a gate of the second switch transistor T02 serves as a control terminal of the second switch module 220, and the second switch transistor T02 is connected between a data line Data and the first power line V1. FIG. 12 shows a case where both the first switch transistor T01 and the second switch transistor T02 are P-type transistors, but this is not limiting. In some other embodiments, the first switch transistor T01 may also be an N-type transistor, and the second switch transistor T02 may also be an N-type transistor.

In one embodiment, as shown in FIG. 11, during a first reset stage t1, a redundant stage t2, a second reset stage t4, and a light emission stage t5, a first switch control signal Sw1 on a first switch control line SW1 is at an active level, and a first switch module 210 is turned on. A second switch control signal Sw2 on a second switch control line SW2 is at an inactive level, and a second switch module 220 is not turned on. This causes a first power voltage on a third power line V3 to be transmitted to a first power line V1 through the first switch module 210, and the first power line V1 provides the first power voltage to a first terminal of a driving module 110. During a data writing stage t3, the second switch control signal Sw2 on the second switch control line SW2 is at an active level, the second switch module 220 is turned on, the first switch control signal Sw1 on the first switch control line SW1 is at an inactive level, and the first switch module 210 is not turned on. This causes a data voltage on a data line Data to be transmitted to the first power line V1 through the second switch module 220, and the first power line V1 provides the data voltage to the first terminal of the driving module 110.

In one embodiment, one column of pixel circuits corresponds to one first power line V1, and the one first power line V1 corresponds to one first switch module 210 and one second switch module 220.

All first switch modules 210 are connected to a same first switch control line SW1, and all second switch modules 220 are connected to a same second switch control line SW2.

In one embodiment, one column of pixel circuits corresponds to one first power line V1, and the one column of pixel circuits writes data voltages row by row during a data writing stage, which can reduce the number of first power lines. All first switch modules 210 are connected to a same first switch control line SW1, and all second switch modules 220 are connected to a same second switch control line SW2, that is, a first switch control signal Sw1 and a second switch control signal Sw2 are global signals, which can reduce the number of traces and signals, and is beneficial to improving a pixel density of a display panel.

The above specific embodiments do not constitute limitations on the scope of protection of the present application. It should be understood that various modifications, combinations, sub-combinations, and substitutions may be made according to design requirements and other factors. Any modifications, equivalent substitutions, and improvements made within the spirit and principles of the present application should be included within the scope of protection of the present application.

What is claimed is:

1. A pixel circuit, comprising:
a driving module, a first terminal of the driving module being connected to a first power line, and the first power line being configured to transmit a first power voltage and a data voltage to the first terminal of the driving module in a time-division manner;
a light emission control module, a first terminal of the light emission control module being connected to a second terminal of the driving module, a second terminal of the light emission control module being connected to a first terminal of a light emitting device, and the light emission control module being configured to control the driving module to generate a driving current; and
a compensation module, connected between the second terminal of the light emission control module and a control terminal of the driving module,
wherein, the compensation module is configured to, when turned on, transmit a voltage related to the data voltage and a threshold voltage of a transistor in the driving module to the control terminal of the driving module.

2. The pixel circuit according to claim 1, wherein a second terminal of the light emitting device is connected to a second power line, and the second power line is configured to transmit a second power voltage and a third power voltage to the second terminal of the light emitting device in a time-division manner; wherein the third power voltage is smaller than the second power voltage.

3. The pixel circuit according to claim 2, wherein:
a first control terminal of the compensation module is connected to a first scan line, and the compensation module is configured to, at least during a data writing stage, turn on in response to a first scan signal on the first scan line;
a control terminal of the light emission control module is connected to a light emission control line, and the light emission control module is configured to, during the data writing stage and a light emission stage, turn on in response to a light emission control signal on the light emission control line;
the first power line is configured to, during the data writing stage, transmit the data voltage to the first terminal of the driving module, and during the light emission stage, transmit the first power voltage to the first terminal of the driving module; and
the second power line is configured to, during the data writing stage, transmit the second power voltage to the second terminal of the light emitting device, and during the light emission stage, transmit the third power voltage to the second terminal of the light emitting device.

4. The pixel circuit according to claim 2, wherein the pixel circuit further comprises:
a reset module, wherein the reset module is connected between a reset signal line and the second terminal of the light emission control module, a control terminal of the reset module is connected to a second scan line, and the reset module is configured to, during a first reset stage, turn on in response to a second scan signal on the second scan line, to transmit a reset voltage on the reset signal line to the second terminal of the light emission control module;
wherein the compensation module is configured to, during the first reset stage, turn on in response to a first scan signal on a first scan line, to transmit the reset voltage to the control terminal of the driving module;
the first power line is configured to, during the first reset stage, transmit the first power voltage to the first terminal of the driving module; and
the second power line is configured to, during the first reset stage, transmit the second power voltage to the second terminal of the light emitting device.

5. The pixel circuit according to claim 4, wherein the compensation module is configured to, at least during a data writing stage, turn on in response to a first scan signal on a first scan line; and the light emission control module is configured to, during the data writing stage and a light emission stage, turn on in response to a light emission control signal on a light emission control line;
the reset module is further configured to, during a second reset stage, turn on in response to the second scan signal to transmit the reset voltage to the first terminal of the light emitting device; and
the first reset stage is before the data writing stage, the second reset stage is after the data writing stage, and the light emission stage is after the second reset stage.

6. The pixel circuit according to claim 4, wherein the compensation module is configured to, at least during a data writing stage, turn on in response to a first scan signal on a first scan line;
the reset module is further configured to, during a redundant stage, turn off in response to the second scan signal; wherein the redundant stage is between the first reset stage and the data writing stage;
the compensation module is further configured to, during the redundant stage, turn off in response to the first scan signal, and the light emission control module is further configured to, during the redundant stage, turn off in response to a light emission control signal; and
the second power line is further configured to, during a second reset stage, transmit the third power voltage to the second terminal of the light emitting device.

7. The pixel circuit according to claim 1, wherein the pixel circuit further comprises a storage module;
a first terminal of the storage module is connected to a third power line, a second terminal of the storage module is connected to the control terminal of the driving module, and the storage module is configured to maintain a potential of the control terminal of the driving module.

8. The pixel circuit according to claim 4, wherein:
the second scan signal is a global signal; and
the second power voltage and the third power voltage are global signals.

9. The pixel circuit according to claim 4, wherein a second control terminal of the reset module is connected to the reset signal line.

10. The pixel circuit according to claim 4, wherein:
the driving module comprises a driving transistor;
a first electrode of the driving transistor is connected to the first power line, a second electrode of the driving transistor is connected to the first terminal of the light emission control module, and a gate of the driving transistor is connected to the compensation module;
the compensation module comprises a compensation transistor;
the compensation transistor is connected between the second terminal of the light emission control module and the control terminal of the driving module;
the light emission control module comprises a light emission control transistor;
a first electrode of a light emission control transistor is connected to the second terminal of the driving module, a second electrode of the light emission control transistor is connected to the first terminal of the light emitting device, and a gate of the light emission control transistor is connected to a light emission control line;
the reset module comprises a reset transistor,
the reset transistor is connected between the reset signal line and the second terminal of the light emission control module, a first gate of the reset transistor is connected to the second scan line, and a second gate of the reset transistor is connected to the reset signal line;
a type of the reset transistor is different from a type of at least one of the driving transistor, the light emission control transistor, and the compensation transistor;
the storage module comprises a storage capacitor; and
a first electrode of the storage capacitor is connected to a third power line, and a second electrode of the storage capacitor is connected to the control terminal of the driving module.

11. The pixel circuit according to claim 4, wherein a second control terminal of the compensation module is connected to a third power line, and the third power line is configured to transmit a first power voltage to the second control terminal of the compensation module;
an absolute value of a first voltage corresponding to an active level of the second scan signal is smaller than an absolute value of a second voltage corresponding to an inactive level of the second scan signal;
or, the second control terminal of the compensation module is connected to the reset signal line;
an absolute value of a first voltage corresponding to an active level of the second scan signal is greater than an absolute value of a second voltage corresponding to an inactive level of the second scan signal; and
the compensation module comprises a compensation transistor, the compensation transistor is connected between the second terminal of the light emission control module and the control terminal of the driving module, a first gate of the compensation transistor is the first control terminal of the compensation module, and a second gate of the compensation transistor is the second control terminal of the compensation module.

12. The pixel circuit according to claim 4, wherein a reset voltage on the reset signal line is a direct current voltage;
or, a reset voltage on the reset signal line is an Alternating Current voltage, and the reset voltage comprises a first sub-voltage and a second sub-voltage;
when a voltage transmitted by the second power line to the second terminal of the light emitting device transitions from the second power voltage to the third power voltage, a voltage on the reset signal line transitions from the first sub-voltage to the second sub-voltage; and the second sub-voltage is smaller than the first sub-voltage.

13. The pixel circuit according to claim 12, wherein the first sub-voltage is greater than the second power voltage, and the second sub-voltage is greater than the third power voltage;
a voltage difference between the first sub-voltage and the second power voltage is the same as a voltage difference between the second sub-voltage and the third power voltage; or, a voltage difference between the second sub-voltage and the third power voltage is smaller than a voltage difference between the first sub-voltage and the second power voltage.

14. A pixel circuit, comprising:
a driving module, wherein a first terminal of the driving module is connected to a first power line, and the first power line is configured to transmit a first power voltage and a data voltage to the first terminal of the driving module in a time-division manner; and
a light emission control module, wherein a first terminal of the light emission control module is connected to a second terminal of the driving module, a second terminal of the light emission control module is connected to a first terminal of a light emitting device, and the light emission control module is configured to control the driving module to generate a driving current;
wherein a second terminal of the light emitting device is connected to a second power line, and the second power line is configured to transmit a second power voltage and a third power voltage to the second terminal of the light emitting device in a time-division manner; and wherein the third power voltage is smaller than the second power voltage.

15. The pixel circuit according to claim 14, wherein the pixel circuit further comprises:
a compensation module, connected between the second terminal of the light emission control module and a control terminal of the driving module, wherein when the compensation module is turned on, the compensation module is configured to, transmit a voltage related to a data voltage and a threshold voltage of a transistor in the driving module to the control terminal of the driving module;
the pixel circuit further comprises:
a reset module, wherein the reset module is connected between a reset signal line and the second terminal of the light emission control module, a control terminal of the reset module is connected to a second scan line, and the reset module is configured to, during a first reset stage, in response to a second scan signal on the second scan line, turn on to transmit a reset voltage on the reset signal line to the second terminal of the light emission control module; and
a storage module, wherein a first terminal of the storage module is connected to a third power line, a second terminal of the storage module is connected to the control terminal of the driving module, and the storage module is configured to maintain a potential of the control terminal of the driving module.

16. A driving method for a pixel circuit, wherein the pixel circuit comprises: a driving module, a light emission control module, and a compensation module, a first terminal of the driving module is connected to a first power line, a first terminal of the light emission control module is connected to a second terminal of the driving module, a second terminal of the light emission control module is connected to a first terminal of a light emitting device, and the compensation module is connected between the second terminal of the light emission control module and a control terminal of the driving module;
the driving method comprising:
during a data writing stage, controlling the first power line to transmit a data voltage to the first terminal of the driving module, controlling the light emission control module and the compensation module to turn on, and transmitting a voltage related to the data voltage and a threshold voltage of a transistor in the driving module to the control terminal of the driving module; and
during a light emission stage, controlling the light emission control module to turn on, to cause the driving module to generate a driving current.

17. The method according to claim 16, wherein the pixel circuit further comprises a reset module, and the reset module is connected between a reset signal line and the second terminal of the light emission control module;
before the data writing stage, the driving method further comprises:
during a first reset stage, controlling the compensation module and the reset module to turn on, to cause the reset module to transmit a reset voltage on the reset signal line to the second terminal of the light emission control module, and the compensation module to transmit the reset voltage to the control terminal of the driving module;
during the first reset stage, the driving method further comprises:
controlling the first power line to transmit a first power voltage to the first terminal of the driving module; and
after the data writing stage and before the light emission stage, the driving method further comprises:
during a second reset stage, controlling the reset module to turn on, to cause the reset module to transmit a reset voltage on the reset signal line to the second terminal of the light emission control module.

18. A display panel, comprising a plurality of pixel circuits, wherein the pixel circuit is the pixel circuit according to claim 1;
a control terminal of a light emission control module in the pixel circuit is connected to a light emission control line, and the light emission control module is configured to, during a data writing stage and a light emission stage, turn on in response to an active level of a light emission control signal on the light emission control line;
control terminals of light emission control modules in one row of the pixel circuits are connected to a same light emission control line;
during the data writing stage in one display frame, an active level of a light emission control signal corresponding to an (m+1)th row of pixel circuits is delayed by one row time relative to an active level of a light emission control signal corresponding to an mth row of pixel circuits; wherein m is a positive integer; and
during the light emission stage in the one display frame, light emission control signals corresponding to all of the pixel circuits simultaneously transition from an inactive level to the active level.

19. The display panel according to claim 18, wherein the pixel circuit comprises a compensation module, a first control terminal of the compensation module is connected to a first scan line, and the compensation module is configured to, during a first reset stage and the data writing stage, turn on in response to an active level of a first scan signal on the first scan line;
control terminals of compensation modules in one row of the pixel circuits are connected to a same first scan line;
during the first reset stage in the one display frame, first scan signals corresponding to all of the pixel circuits simultaneously transition from an inactive level to the active level, and then, simultaneously transition from the active level to the inactive level;
during the data writing stage in the one display frame, an active level of a first scan signal corresponding to an (m+1)th row of pixel circuits is delayed by one row time relative to an active level of a first scan signal corresponding to an mth row of pixel circuits;
the pixel circuit further comprises a reset module, the reset module is connected between a reset signal line and a second terminal of the light emission control module, a control terminal of the reset module is connected to a second scan line, and the reset module is configured to, during a first reset stage, turn on in response to a second scan signal on the second scan line to transmit a reset voltage on the reset signal line to the second terminal of the light emission control module;
control terminals of reset modules in one row of the pixel circuits are connected to a same second scan line;
during the first reset stage in the one display frame, second scan signals corresponding to all of the pixel circuits simultaneously transition from an inactive level to an active level, and then, simultaneously transition from the active level to the inactive level;
the reset module is further configured to, during a second reset stage, turn on in response to the second scan signal on the second scan line;
during the second reset stage in the one display frame, second scan signals corresponding to all of the pixel circuits simultaneously transition from an inactive level to an active level, and then, simultaneously transition from the active level to the inactive level; and
second terminals of all light emitting devices are connected to a same second power line.

20. The display panel according to claim 19, wherein a second control terminal of the compensation module is connected to a reset signal line or a third power line;
the display panel further comprises a plurality of first switch modules and a plurality of second switch modules;
the first switch module is connected between the third power line and a first power line, a control terminal of the first switch module is connected to a first switch control line; and the first switch module is configured to, during the first reset stage, a light emission stage, and a second reset stage, turn on in response to a first switch control signal on the first switch control line to transmit a first power voltage on the third power line to the first power line;
the second switch module is connected between a data line and the first power line, a control terminal of the second switch module is connected to a second switch control line; and the second switch module is configured to, during a data writing stage, turn on in response to a second switch control signal on the second switch control line, to transmit a data voltage on the data line to the first power line;
one column of pixel circuits corresponds to one first power line, and the one first power line corresponds to one first switch module and one second switch module; and
all of the first switch modules are connected to a same first switch control line, and all of the second switch modules are connected to a same second switch control line.
